(19) United States
(12) Patent Application Publication
(10) Pub. No.: US 2021/0044124 A1
(43) Pub. Date: Feb. 11, 2021

(54) Dock Base for Wirelessly Charging Intelligent Handheld Devices

(71) Applicant: Chia-Hua LIN, New Taipei City (TW)

(72) Inventor: Chia-Hua LIN, New Taipei City (TW)

(21) Appl. No.: 16/534,145

(22) Filed: Aug. 7, 2019

(51) Int. Cl. H02J 7/00; H02J 7/02

(52) U.S. Cl. CPC H02J 7/0044; H02J 7/0027; H02J 7/025

(57) ABSTRACT

A dock base for wirelessly charging intelligent handheld devices according to the present invention is disclosed, comprises: a body, whose one or both side(s) can be configured with a dock section, in which the dock section includes a base having an inward tilted surface and a back leaning part have a tilted back leaning plane, and the angle formed between the inward tilted surface and the horizontal plane of the bottom part of the body is 15˜25 degrees, while the angle formed between the inward tilted surface and the tilted back leaning plane is 70˜85 degrees; moreover, a wireless charging unit, installed inside the back leaning part. The intelligent device can naturally lean back against the tilted back leaning plane due to the design of the dock angle, and then be wirelessly charged by means of the wireless charging unit.

### BACKGROUND OF THE INVENTION

### 1. Field of the Invention

The present invention generally relates to a dock base for wirelessly charging intelligent handheld devices; in particular, it relates to a wireless charging dock base that allows an intelligent device to naturally lean back without slipping down in order to be wirelessly charged.

### 2. Description of Related Art

In recent years, with the development regarding to various information and telecommunication technologies, portable electronic devices (e.g., mobile phones, smart phones, etc.) have become indispensable parts of people's daily lives or work. Generally, such portable electronic devices are all commonly equipped with rechargeable batteries to store and provide electric power required for the operations of the portable electronic device, and once the power is exhausted, they need to be recharged.

Therefore, in order to facilitate the user to charge the portable electronic device, wireless charging technologies have been developed, and the wireless charging applies the electromagnetic resonance or electromagnetic induction approaches to transfer the electric energy to the portable electronic device so that the battery installed in the portable electronic device can be effectively charged. In this way, the portable electronic device can be charged without any wiring connections, thereby increasing convenience.

Whereas, the wireless chargers currently available on the market can only be applied to charge in a horizontal manner, so the user may not clearly see the important information or the incoming phone calls shown on the display panel during the operation, and that is why a sort of upright-standing wireless chargers have been gradually developed in the industries. But, as shown in FIGS. 1A-1B, in actual use, the portable electronic device 1 may frequently encounter a slide-down problem and can not be stably positioned thereon, so the wireless charger 2 must be configured with a blocker 21 in order to prevent this issue. Yet, even if there is the presence of the blocker 21, once the portable electronic device 1 slides down, suppose it is separated from the back leaning plane of the wireless charger 2 by a certain distance, the problem of wireless charging interruption may undesirably occur as well.

In addition to the above-mentioned issues, it should be understood that, as shown in FIG. 1C, upon using the portable electronic device 1 to watch a movie, the blocker 21 tends to block the lower portion of the video playback interface 11, which may become very annoying for most of users. Therefore, how to allow the portable electronic device to be stably positioned for wireless charging operations and not to cover the video playback interface when playing a movie is the issue to be solved in the present application.

As such, in order to improve the aforementioned situations, the present invention designs a dock base for wirelessly charging intelligent handheld devices which enables the intelligent device to lean backwards and naturally and to be stably positioned upon using it to wirelessly charge the intelligent device, thereby providing an optimal solution.

### SUMMARY OF THE INVENTION

A dock base for wirelessly charging intelligent handheld devices is disclosed, used for docking and charging an intelligent device and comprising: a body, having a bottom part which is a plane, and configured with a dock section on one side of the body, in which the dock section includes: a base, having an inward tilted surface, and the angle formed between the inward tilted surface and the horizontal plane of the bottom part being 15˜25 degrees, in which the inward tilted surface has two long sides and two short sides; a back leaning part, having a tilted back leaning plane, in which the tilted back leaning plane can extend downwards and be connected to the inward tilted surface and form a dock angle which is 70˜85 degrees; and a wireless charging unit, installed inside the back leaning part and including: an electric circuit board module for electrically connecting to an external power source and capable of providing the required power source in order to charge the dock base for wirelessly charging intelligent handheld devices; and a coil module, electrically connected to the electric circuit board module, in which the coil module can be used as a charging transmitting end so as to wirelessly transmit the power provided by the electric circuit board module to the intelligent device.

More specifically, the other side of the body can be also provided with the dock section.

More specifically the angle formed between the tilted back leaning plane and the horizontal plane of the bottom part is 60˜80 degrees.

More specifically, the surface of the tilted back leaning plane is installed thereon with a spacer, and the spacer has an opening, and the position of the opening corresponds to the position where the coil module is disposed, and the spacer is used to generate a distance difference of 1˜4 mm between the coil module and the intelligent device.

More specifically, the surface of the tilted back leaning plane is installed with a notch at the position corresponding the coil module, and the notch is used to generate a distance difference of 1˜4 mm between the coil module and the intelligent device.

More specifically, the intelligent device is a tablet computer or a smart phone.

More specifically, the surface on any sides of the back leaning part is set up with one or more USB connection holes electrically connected to the electric circuit board module.

### BRIEF DESCRIPTION OF THE DRAWINGS

FIG. 1A shows an implementation view of a conventional wireless charging device.

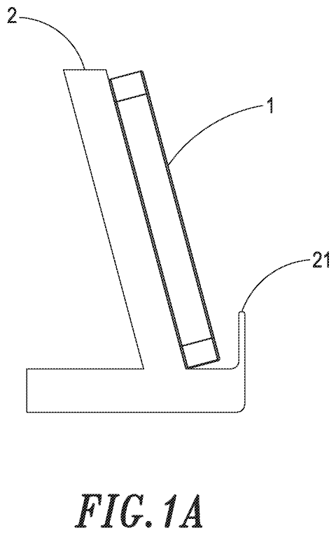

FIG. 1B shows an implementation view of a conventional wireless charging device.

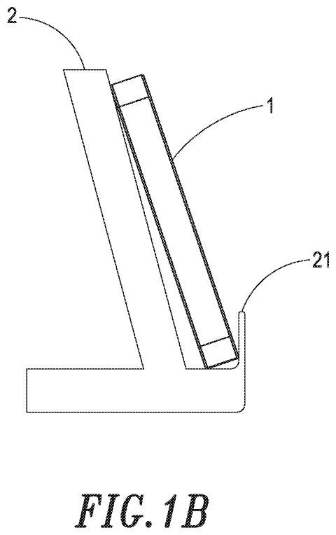

FIG. 1C shows an implementation view of a conventional wireless charging device.

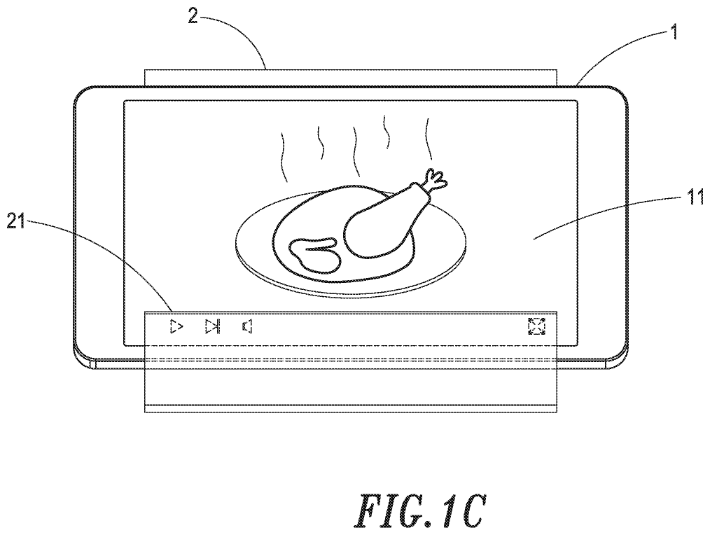

FIG. 2A shows a view for the stereo structure of the dock base for wirelessly charging intelligent handheld devices according to the present invention.

FIG. 2B shows a view for the dock angle of the dock base for wirelessly charging intelligent handheld devices according to the present invention.

FIG. 2C shows a view for the planar structure, at another view angle, of the dock base for wirelessly charging intelligent handheld devices according to the present invention.

FIG. 2D shows a view for the structure of the wireless charging unit in the dock base for wirelessly charging intelligent handheld devices according to the present invention.

FIG. 3 shows an implementation view for the placement of the dock base for wirelessly charging intelligent handheld devices according to the present invention.

FIG. 4A shows a view for another implementation structure of the dock base for wirelessly charging intelligent handheld devices according to the present invention.

FIG. 4B shows a view for another placement implementation of the dock base for wirelessly charging intelligent handheld devices according to the present invention.

FIG. 5A shows a structural decomposition view for the spacer of the dock base for wirelessly charging intelligent handheld devices according to the present invention.

FIG. 5B shows a structural composition view for the spacer of the dock base for wirelessly charging intelligent handheld devices according to the present invention.

FIG. 5C shows an implementation view for the placement of the dock base for wirelessly charging intelligent handheld devices according to the present invention.

FIG. 6 shows a structure and placement view for the notch of the dock base for wirelessly charging intelligent handheld devices according to the present invention.

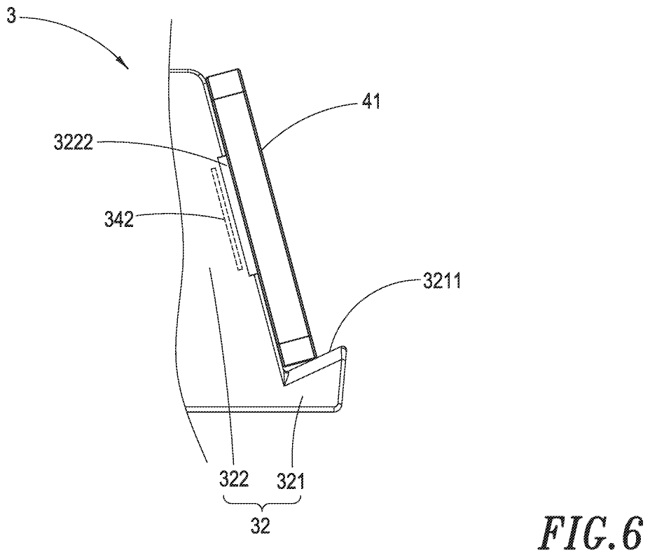

FIG. 7 shows an implementation view for the USB connection holes of the dock base for wirelessly charging intelligent handheld devices according to the present invention.

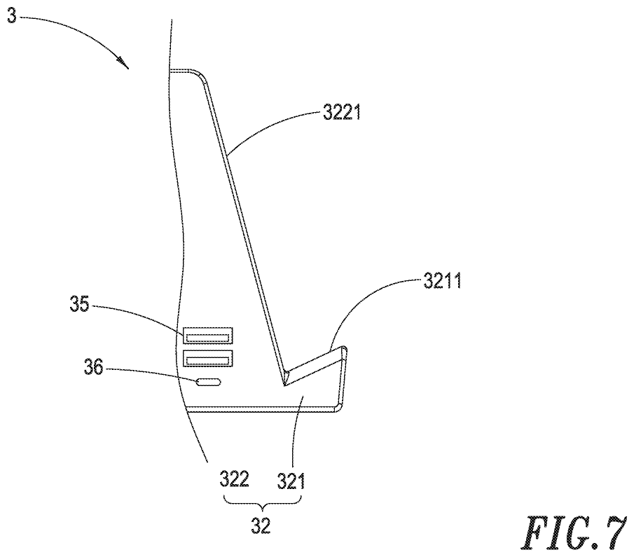

### DETAILED DESCRIPTION OF THE PREFERRED EMBODIMENTS

Other technical contents, aspects and effects in relation to the present invention can be clearly appreciated through the detailed descriptions concerning the preferred embodiments of the present invention in conjunction with the appended drawings.

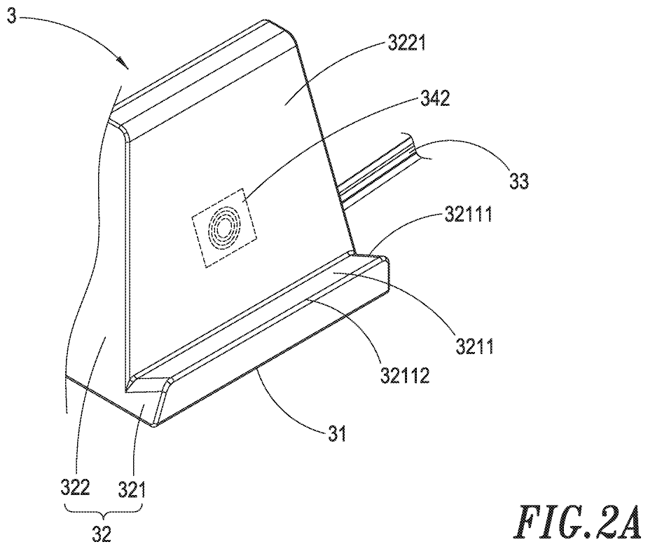

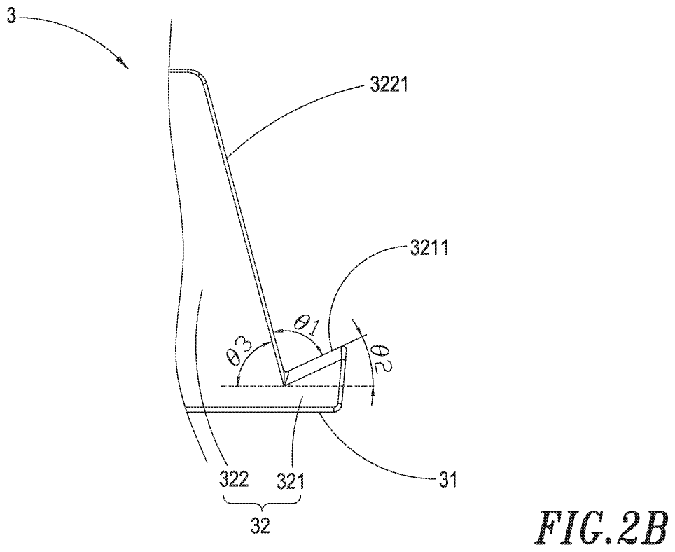

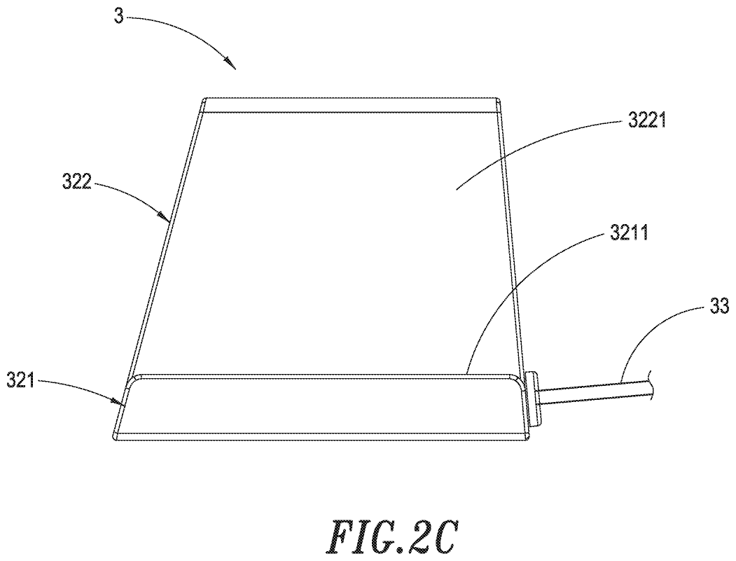

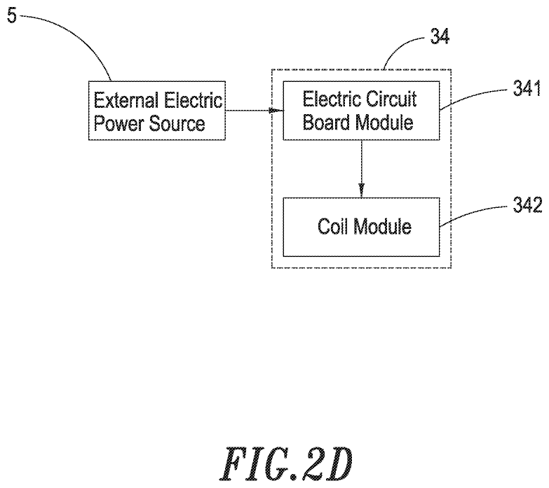

Refer first to FIGS. 2A˜2D, wherein a view for the stereo structure, a view for the dock angle, a view for the planar structure at another view angle, as well as a view for the structure of the wireless charging unit, of the dock base for wirelessly charging intelligent handheld devices according to the present invention are respectively shown. As shown in the Figures, the dock base for wirelessly charging intelligent handheld devices in the present embodiment comprises a body 3 which has a planar bottom part 31, and one side of the body 3 is installed with a dock section 32 which includes a base 321 and a back leaning part 322.

Herein the base 321 has an inward tilted surface 3211, and the angle Θ₂ formed between the inward tilted surface 3211 and the horizontal plane of the bottom part 31 may range 15˜25 degrees, in which the inward tilted surface 3211 has two long sides 32112 and two short sides 32111.

In addition, the back leaning part 322 has a tilted back leaning plane 3221, and the angle Θ₃ formed between the tilted back leaning plane 3221 and the horizontal plane of the bottom part 31 may range 60-80 degrees, and, also, the tilted back leaning plane 3221 can extend downwards and connect to the inward tilted surface 3211 to form a dock angle Θ₁ ranging 70˜85 degrees.

Besides, a wireless charging unit 34 is disposed inside the back leaning part 322 and includes an electric circuit board module 341 and a coil module 342. Herein the electric circuit board module 341 can be electrically connected to an external power source 5 by way of an electric power line 33 in order to provide the required power source that the dock base for wirelessly charging intelligent handheld devices needs to operate. Moreover, the coil module 342 can be used as a charging transmitting end so as to wirelessly transmit the power provided by the electric circuit board module 341 to the intelligent device.

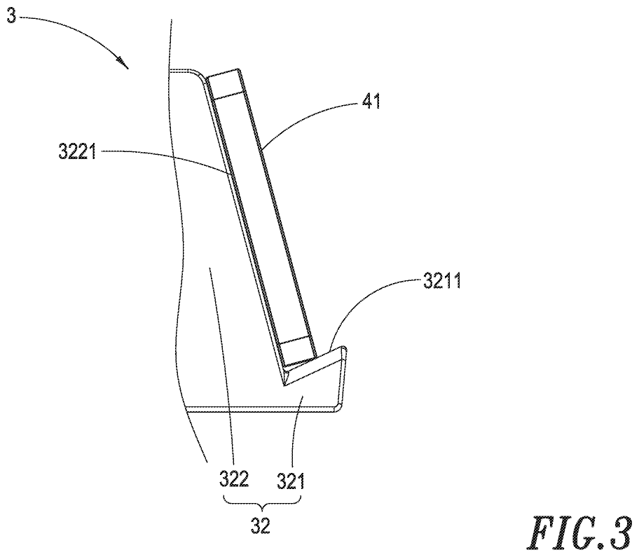

Since the present invention has designed the dock angles Θ₁, the angle Θ₂ and the angle Θ₃, as shown in FIG. 3, when the intelligent device 41 is placed on the dock section 32, it will naturally lean against the tilted back leaning plane 3221 and will not slide forward, so the distance between the intelligent device 41 and the tilted back leaning plane 3221 will not become exceedingly large, thus not significantly affecting its wireless charging operations.

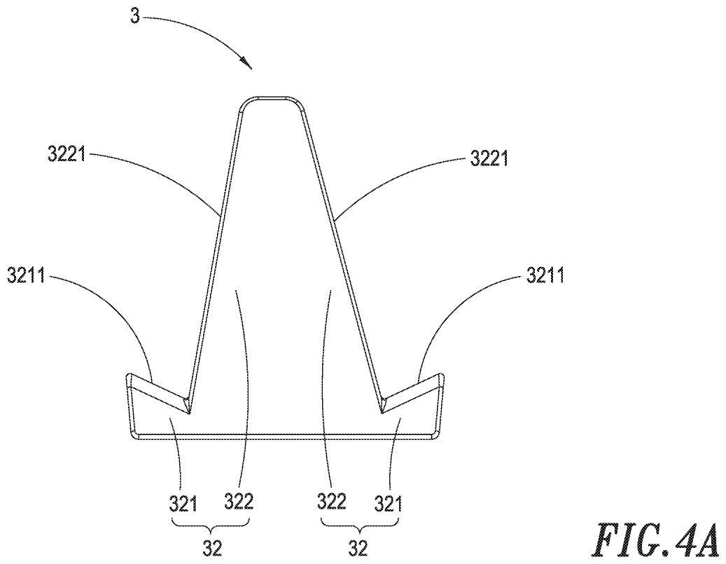

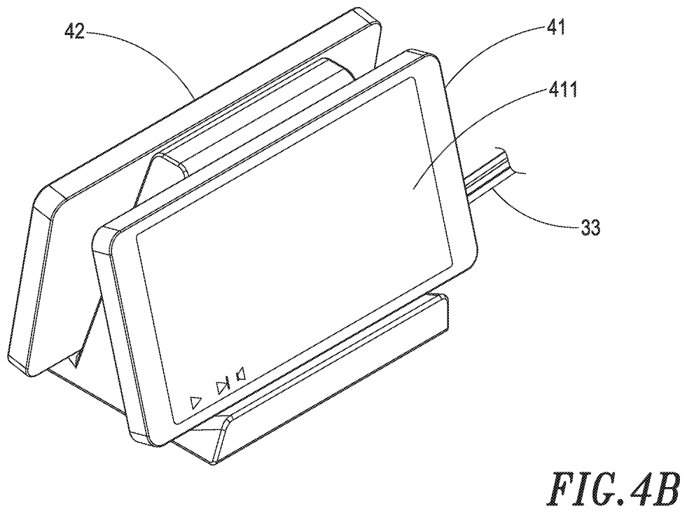

In addition, as shown in FIG. 4A, the other side of the body 3 can be also provided with the dock section 32, and, from FIGS. 4A and 4B, it can be seen that, since the base 321 doesn't have the obvious and protrusive blocker, when the intelligent device 41 is placed horizontally thereon to display the contents played in the movie playback interface 411 of the intelligent device 41, the lower edge of the screen will not be undesirably blocked. Further, seeing that the present embodiment has the dock sections 32 respectively on the two sides, two users can individually use different intelligent devices 41,42 to watch movies in a face-to-face fashion and perform electric charging operations at the same time.

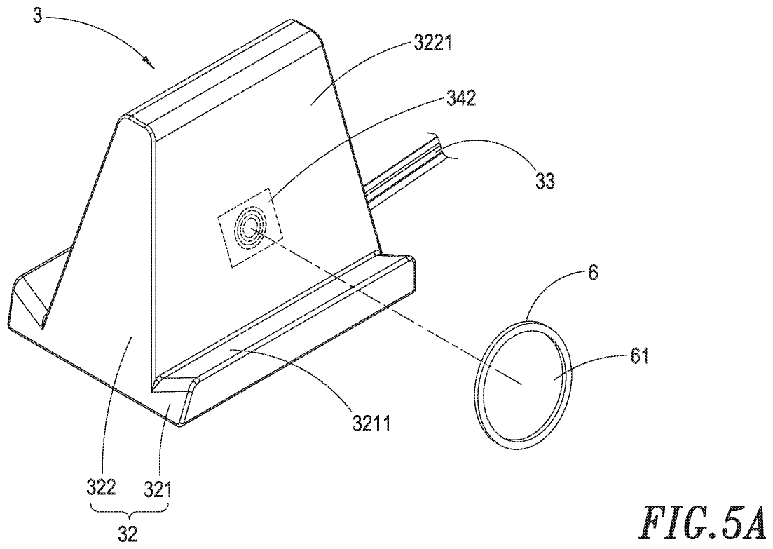

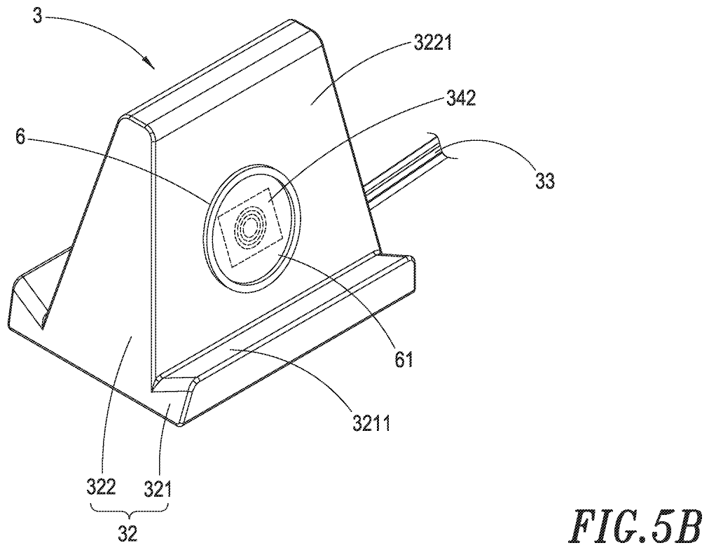

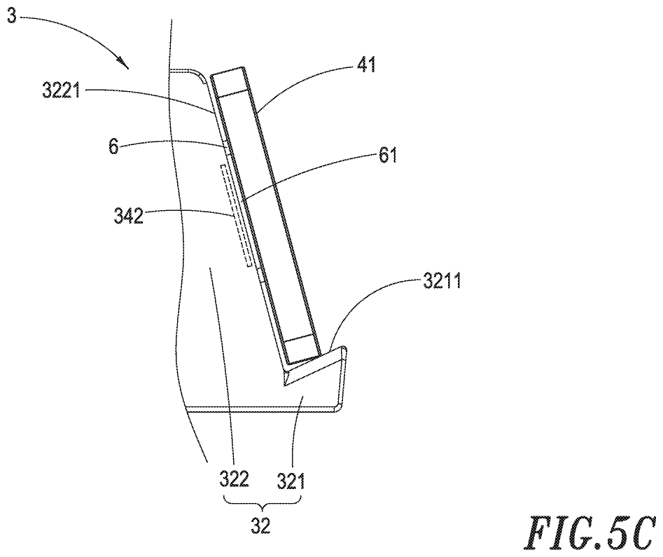

Moreover, the tilted back leaning plane 3221 must have a certain gap distance from the intelligent device placed thereon so as to avoid potential security problems caused by the exceedingly close distance. Hence, as shown in FIGS. 5A-5C, a spacer 6 is combined with the tilted back leaning plane 3221 thereon and includes an opening 61 whose position corresponds to the position at which the coil module 342 is disposed. Thus, as shown in FIG. 5C, upon placing the intelligent device 41 against the tilted back leaning plane 3221, the spacer 6 can generate a distance difference of 1˜4 mm between the coil module 342 and the intelligent device 41.

Additionally, the spacer 6 can be made of a non-slip material, and when the intelligent device 41 is placed against the tilted back leaning plane 3221, the friction occurring on the rear surface of the intelligent device 41 may increase such that the intelligent device 41 can be more stably positioned on the tilted back leaning plane 3221.

Besides, in addition to the previously described spacer 6, the surface of the tilted back leaning plane 3221 can be further set up with a notch 3222 at the position corresponding to the coil module 342, and the notch 3222 can be also used to generate a distance difference of 1˜4 mm between the coil module 342 and the intelligent device 41.

Furthermore, the surface on any sides of the back leaning part 322 can be configured with one or more USB connection holes 35, 36 electrically connected to the electric circuit board module 341, in which the USB connection hole 35 is a USB-A hole, while the USB connection hole 36 is a Type-C hole.

In comparison with other conventional technologies, the dock base for wirelessly charging intelligent handheld devices according to the present invention provides the following advantages:
(1) It can be appreciated that the present invention designs a dock base for wirelessly charging intelligent handheld devices which enables the intelligent device to lean backwards and naturally and to be stably positioned upon using it to wirelessly charge the intelligent device;
(2) When a user applies the present invention to horizontally display the video contents, the lower edge of the video interface will not be undesirably blocked, so it is possible to enjoy watching the movie while wirelessly charging the intelligent device at the same time.

It should be noticed that, although the present invention has been disclosed through the detailed descriptions of the aforementioned embodiments, such illustrations are by no means used to restrict the scope of the present invention; that is, skilled ones in relevant fields of the present invention can certainly devise any applicable alterations and modifications after having comprehended the aforementioned technical characteristics and embodiments of the present invention without departing from the spirit and scope thereof. Hence, the scope of the present invention to be protected under patent laws should be delineated in accordance with the claims set forth hereunder in the present specification.

What is claimed is:

1. A dock base for wirelessly charging intelligent handheld devices, which is used for docking and charging an intelligent device and comprises:
a body, having a bottom part which is a plane, and configured with a dock section on one side of the body, in which the dock section includes:
a base, having an inward tilted surface, and the angle formed between the inward tilted surface and the horizontal plane of the bottom part being 15˜25 degrees, in which the inward tilted surface has two long sides and two short sides;
a back leaning part, having a tilted back leaning plane, in which the tilted back leaning plane can extend downwards and be connected to the inward tilted surface and form a dock angle which is 70˜85 degrees; and
a wireless charging unit, installed inside the back leaning part and including:
an electric circuit board module for electrically connecting to an external power source and capable of providing the required power source in order to charge the dock base for wirelessly charging intelligent handheld devices; and
a coil module, electrically connected to the electric circuit board module, in which the coil module can be used as a charging transmitting end so as to wirelessly transmit the power provided by the electric circuit board module to the intelligent device.

2. The dock base for wirelessly charging intelligent handheld devices according to claim 1, wherein the other side of the body can be also provided with the dock section.

3. The dock base for wirelessly charging intelligent handheld devices according to claim 1, wherein the angle formed between the tilted back leaning plane and the horizontal plane of the bottom part is 60˜80 degrees.

4. The dock base for wirelessly charging intelligent handheld devices according to claim 1, wherein the surface of the tilted back leaning plane is installed thereon with a spacer, and the spacer has an opening, and the position of the opening corresponds to the position where the coil module is disposed, and the spacer is used to generate a distance difference of 1˜4 mm between the coil module and the intelligent device.

5. The dock base for wirelessly charging intelligent handheld devices according to claim 1, wherein the surface of the tilted back leaning plane is installed with a notch at the position corresponding to the position of the coil module, and the notch is used to generate a distance difference of 1˜4 mm between the coil module and the intelligent device.

6. The dock base for wirelessly charging intelligent handheld devices according to claim 1, wherein the intelligent device is a tablet computer or a smart phone.

7. The dock base for wirelessly charging intelligent handheld devices according to claim 1, wherein the surface on any sides of the back leaning part is set up with one or more USB connection holes electrically connected to the electric circuit board module.
